(19) United States
(12) Patent Application Publication
(10) Pub. No.: US 2017/0120573 A1
(43) Pub. Date: May 4, 2017

(54) CYLINDER ETCHING APPARATUS

(71) Applicant: THINK LABORATORY CO., LTD., Chiba (JP)

(72) Inventor: Tatsuo SHIGETA, Chiba (JP)

(21) Appl. No.: 15/301,756

(22) PCT Filed: Feb. 27, 2015
(86) PCT No.: PCT/JP2015/055850

§ 371 Date: Oct. 4, 2016

(30) Foreign Application Priority Data
Apr. 9, 2014 (JP) 2014-080285

(51) Int. Cl. B41C 1/18; C23F 1/20; C23F 1/08

(52) U.S. Cl. CPC B41C 1/188; C23F 1/08; C23F 1/20

(57) ABSTRACT

Provided is a cylinder etching apparatus, which is capable of performing etching more uniformly than in the prior art and is also capable of solving a problem in that a remaining etching solution in an etching solution supply tube flows down therefrom. The cylinder etching apparatus includes: a processing bath; chuck means; at least one etching solution supply tube; and a plurality of ejection nozzles juxtaposed in the etching solution supply tube and configured to eject an etching solution from the etching solution supply tube. The etching solution ejected from the ejection nozzles through the etching solution supply tube is caused to impinge against a surface of the cylinder to be processed, to thereby etch the surface of the cylinder to be processed. The ejection nozzles are oriented obliquely upward with respect to a horizontal direction. An ejection direction of the ejection nozzle is oriented toward a rotation center of the cylinder to be processed from a position that is obliquely downward of the cylinder to be processed. The ejection nozzles are arranged so as to be brought closer to and away from the surface of the cylinder to be processed.

### TECHNICAL FIELD

The present invention relates to a cylinder etching apparatus configured to etch a cylinder to be processed that is a plate material for forming a printing surface in manufacturing an elongated cylinder, such as a hollow tubular gravure cylinder (also called a plate-making roll) to be used for gravure printing.

### BACKGROUND ART

In gravure printing, minute recesses (cells) are formed in a cylinder to be processed based on plate-making information to produce a printing surface, and the cells are filled with ink so that the ink is transferred onto an object to be printed. In general gravure cylinders, a tubular iron or aluminum core (hollow roll) is used as a base, and a plurality of layers such as an underlying layer and a separation layer are formed on an outer peripheral surface of the base. On those layers, a copper plating layer for forming a printing surface (plate material) is formed. Then, gravure cells are formed in the copper plating layer by exposure, developing, and etching, and then the resultant base is plated with chromium or any other substance for enhancing printing durability of the gravure cylinder. In this manner, plate making (production of a printing surface) is completed.

As a cylinder etching apparatus, there is known, for example, an etching apparatus for a roll to be processed described in Patent Document 1. The etching apparatus in Patent Document 1 can produce a mesh gravure plate with minimized side etching by keeping a distance between nozzles and a roll to be processed to be a constant dimension, to thereby optimize the force of an etching solution that is caused to impinge against an exposed metal surface, irrespective of a diameter of the roll to be processed.

However, in Patent Document 1, the nozzles configured to eject the etching solution are oriented horizontally or obliquely downward toward the roll to be processed. Therefore, the flow of the etching solution is unsatisfactory, thereby causing a risk in that etching may become non-uniform. Further, when the nozzles are oriented horizontally or obliquely downward, a remaining etching solution in an etching solution supply tube drops from the nozzles due to the gravity, thereby also causing a problem that a cylinder to be processed may be soiled.

### PRIOR ART DOCUMENTS

### Patent Document

Patent Document 1: JP Hei 09-268384 A

Patent Document 2: WO 2012/043515 A1

### SUMMARY OF THE INVENTION

### Problems to be Solved by the Invention

The present invention has been made in view of the above-mentioned problems inherent in the prior art, and it is therefore an object of the present invention to provide a cylinder etching apparatus, which is capable of performing etching more uniformly than in the prior art and is also capable of solving the problem that a remaining etching solution in an etching solution supply tube drops therefrom.

### Means for Solving Problems

According to one embodiment of the present invention, there is provided a cylinder etching apparatus, including: a processing bath; chuck means for rotatably holding both ends of a cylinder to be processed in a longitudinal direction of the cylinder to be processed and accommodating the cylinder to be processed in the processing bath; at least one etching solution supply tube arranged at a predetermined distance from an outer peripheral surface of the cylinder to be processed along the longitudinal direction in parallel to the outer peripheral surface of the cylinder to be processed along the longitudinal direction; and a plurality of ejection nozzles juxtaposed in the at least one etching solution supply tube and configured to eject an etching solution from the at least one etching solution supply tube, in which the etching solution ejected from the plurality of ejection nozzles through the at least one etching solution supply tube is caused to impinge against a surface of the cylinder to be processed, to thereby etch the surface of the cylinder to be processed, in which the plurality of ejection nozzles are oriented obliquely upward with respect to a horizontal direction of the cylinder to be processed, in which an ejection direction of each of the plurality of ejection nozzles is oriented toward a rotation center of the cylinder to be processed from a position that is obliquely downward of the cylinder to be processed, and in which the plurality of ejection nozzles are arranged so as to be brought closer to and away from the surface of the cylinder to be processed.

As described above, in the present invention, the ejection nozzles are oriented obliquely upward with respect to the horizontal direction, and the ejection direction of the ejection nozzles is oriented toward the rotation center of the cylinder to be processed from the position that is obliquely downward of the cylinder to be processed. Therefore, the flow of the etching solution on the surface of the cylinder to be processed is satisfactory, and the etching becomes uniform. Further, there is no problem that the remaining etching solution in the etching solution supply tube drops from the nozzles due to the gravity to soil the cylinder to be processed.

As the cylinder to be processed, a cylinder to be processed for a gravure cylinder is preferred.

It is preferred that a line connecting the rotation center of the cylinder to be processed and the ejection direction of the each of the plurality of ejection nozzles to each other form an angle of 45°±15° with respect to a vertical line from the rotation center of the cylinder to be processed.

It is preferred that the at least one etching solution supply tube include a plurality of etching solution supply tubes in which the plurality of ejection nozzles are juxtaposed, that the plurality of etching solution supply tubes be arranged in a circumferential direction of the cylinder to be processed, and that the etching solution be ejected so as to be directed toward the rotation center of the cylinder to be processed from a plurality of directions.

It is further preferred that a total length of each of the plurality of etching solution supply tubes be set to be larger than a total length of the cylinder to be processed, that a tip end portion of the each of the plurality of etching solution supply tubes form a discharge port, and that, in the etching solution passing through the each of the plurality of etching solution supply tubes, the etching solution remaining without being ejected from the plurality of ejection nozzles be discharged from the discharge port, to thereby regulate a flow rate of the etching solution passing through the each of the plurality of etching solution supply tubes.

According to one embodiment of the present invention, there is provided a cylinder etching method, including etching a surface of a cylinder to be processed through use of the above-mentioned cylinder etching apparatus.

Further, according to one embodiment of the present invention, there is provided a cylinder, which is etched by the above-mentioned cylinder etching method. As the cylinder, a gravure cylinder is preferred.

The cylinder etching apparatus of the present invention may be used alone, but may be preferably used as, for example, an etching treatment apparatus in a fully automatic gravure plate-making processing system as described in Patent Document 2.

### Advantageous Effects of the Invention

According to the present invention, it is possible to achieve a remarkable effect of providing the cylinder etching apparatus, which is capable of performing etching more uniformly than in the prior art and is also capable of solving the problem in that the remaining etching solution in the etching solution supply tube flows down therefrom.

Further, when the cylinder etching apparatus according to the present invention is incorporated into the fully automatic gravure plate-making processing system for use, it is also possible to achieve an effect of providing the fully automatic gravure plate-making processing system, which is capable of performing etching more uniformly than in the prior art and is also capable of solving the problem in that the remaining etching solution in the etching solution supply tube flows down therefrom.

### BRIEF DESCRIPTION OF DRAWINGS

FIG. 1 is a schematic side view for illustrating a cylinder etching apparatus according to an embodiment of the present invention.

FIG. 2 is a schematic perspective view for illustrating the cylinder etching apparatus according to the embodiment of the present invention.

FIG. 3 is a schematic view for illustrating the cylinder etching apparatus according to the embodiment of the present invention.

### DESCRIPTION OF EMBODIMENTS

An embodiment of the present invention is described below with reference to the accompanying drawings, but illustrated examples are merely described as examples, and hence it is understood that various modifications may be made without departing from the technical spirit of the present invention.

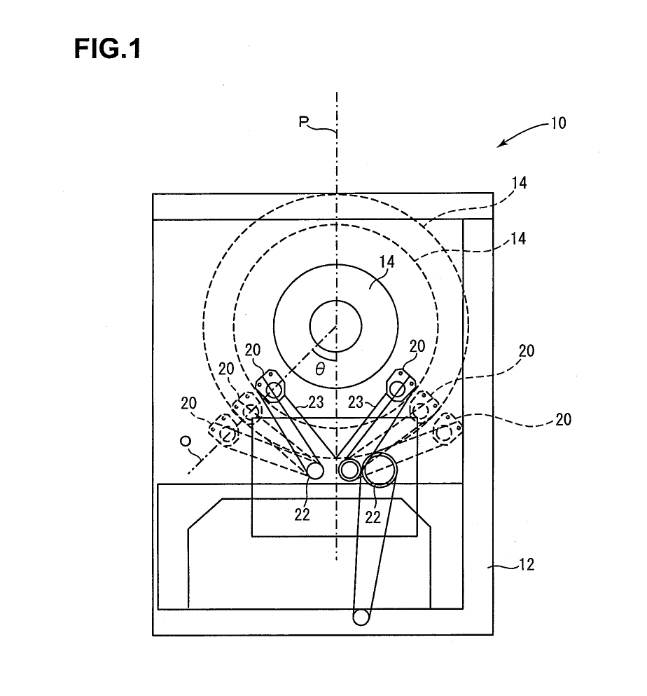

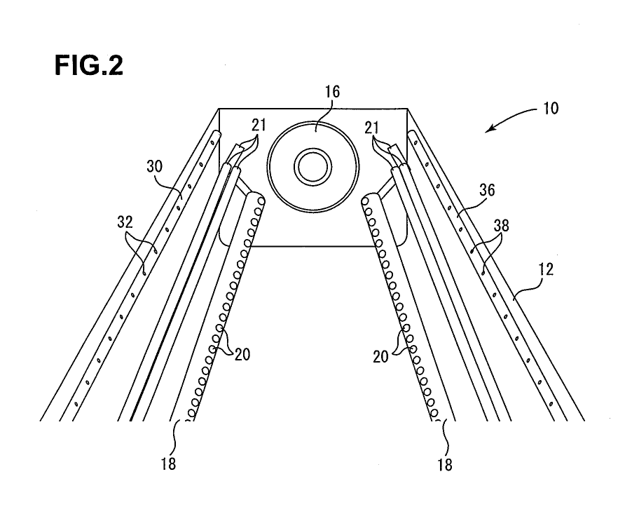

In FIG. 1 and FIG. 2, reference symbol 10 represents a cylinder etching apparatus according to the embodiment of the present invention.

The cylinder etching apparatus 10 includes a processing bath 12, chuck means 16 for rotatably holding both ends of a cylinder 14 to be processed in a longitudinal direction and accommodating the cylinder 14 to be processed in the processing bath 12, at least one etching solution supply tube 18 (two in the illustrated example) arranged at a predetermined distance from an outer peripheral surface of the cylinder 14 to be processed along the longitudinal direction in parallel to the outer peripheral surface thereof along the longitudinal direction, and a plurality of ejection nozzles 20 juxtaposed in the etching solution supply tube 18 and configured to eject an etching solution 19 from the etching solution supply tube 18. The etching solution 19 ejected from the ejection nozzles 20 through the etching solution supply tube 18 is caused to impinge against a surface of the cylinder 14 to be processed, to thereby etch the surface of the cylinder 14 to be processed.

The ejection nozzles 20 are oriented obliquely upward with respect to a horizontal direction so that an ejection direction of the ejection nozzles 20 is oriented toward a rotation center of the cylinder 14 to be processed from a position that is obliquely downward of the cylinder 14 to be processed, and the ejection nozzles 20 are arranged so as to be automatically brought closer to and away from the surface of the cylinder 14 to be processed. As the chuck means 16, publicly-known mechanisms described in Patent Documents 1 and 2 may be adopted.

As a configuration in which the ejection nozzles are arranged so as to be brought closer to and away from the surface of the cylinder 14 to be processed, as illustrated in FIG. 1, the etching solution supply tube 18 is rotatable about a fulcrum 22 so as to be brought closer to and away from the surface of the cylinder 14 to be processed. Further, as clearly illustrated in FIG. 1, there is arranged a connecting rod 23 configured to rotate the etching solution supply tube 18. Reference symbol 21 in FIG. 2 represents a frame configured to support the etching solution supply tube 18.

Thus, a gravure cylinder (gravure plate-making roll) with minimized side etching can be manufactured by keeping a distance between the ejection nozzles 20 and the cylinder 14 to be processed to be a constant dimension, to thereby optimize the force of the etching solution that is caused to impinge against an exposed metal surface, irrespective of a diameter of the cylinder 14 to be processed.

In order that the ejection nozzles 20 are oriented obliquely upward with respect to the horizontal direction so that the ejection direction of the ejection nozzles 20 is oriented toward the rotation center of the cylinder 14 to be processed from the position that is obliquely downward of the cylinder 14 to be processed, it is preferred that a line O connecting the rotation center of the cylinder 14 to be processed and the ejection direction of the ejection nozzle 20 to each other forms an angle of 45°±15° with respect to a vertical line P from the rotation center of the cylinder 14 to be processed.

In the illustrated example, as clearly illustrated in FIG. 1, the line O connecting the rotation center of the cylinder 14 to be processed and the ejection direction of the ejection nozzle 20 to each other forms an angle of) 45° (θ=45° with respect to the vertical line P from the rotation center of the cylinder 14 to be processed.

Further, a plurality (two in the illustrated example) of etching solution supply tubes 18, in which the plurality of ejection nozzles 20 are juxtaposed, are arranged in a circumferential direction of the cylinder 14 to be processed so that the etching solution is ejected so as to be directed toward the rotation center of the cylinder 14 to be processed from a plurality of directions.

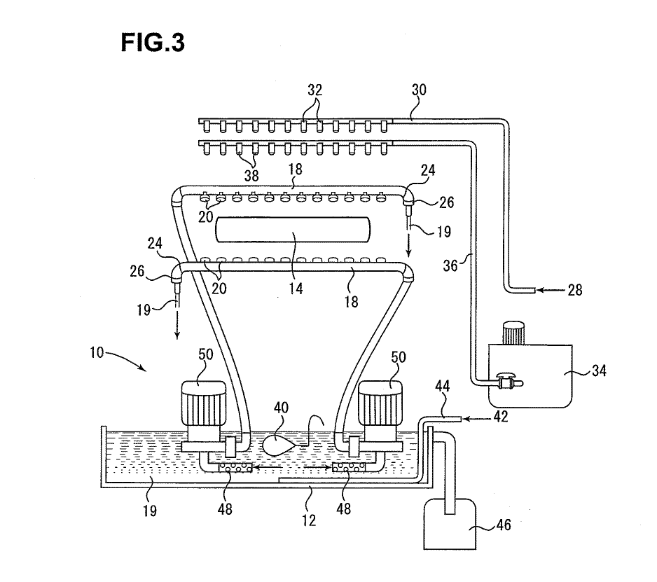

Next, the etching solution supply tube 18 of the cylinder etching apparatus 10 according to the embodiment of the present invention is described with reference to FIG. 3.

As clearly illustrated in FIG. 3, a total length of the etching solution supply tube 18 is set to be larger than a total length of the cylinder 14 to be processed, and a tip end portion 24 of the etching solution supply tube 18 forms a discharge port 26. In the etching solution passing through the etching solution supply tube 18, the etching solution that is not ejected from the ejection nozzles 20 is discharged from the discharge port 26. Thus, through the discharge of the etching solution, which is not ejected from the ejection nozzles 20, from the discharge port 26, the internal pressure of the etching solution supply tube 18 becomes uniform so that the flow rate of the etching solution that passes through the etching solution supply tube 18 to be ejected from the ejection nozzles 20 can be constant. That is, the flow rate of the etching solution that passes through the etching solution supply tube 18 to be ejected from the ejection nozzles 20 can be regulated.

Further, as illustrated in FIG. 2 and FIG. 3, in the cylinder etching apparatus 10, there are arranged a plurality of water-washing spray nozzles 32 configured to wash the cylinder 14 to be processed with water by spraying washing water 28 from the water-washing spray nozzles 32 through a washing water supply tube 30.

Further, as illustrated in FIG. 2 and FIG. 3, in the cylinder etching apparatus 10, there are arranged a plurality of hydrochloric acid spray nozzles 38 configured to clean the cylinder 14 to be processed with hydrochloric acid by spraying hydrochloric acid in a hydrochloric acid sub-tank 34 from the hydrochloric acid spray nozzles 38 through a hydrochloric acid supply tube 36.

Further, as illustrated in FIG. 3, the liquid level of the etching solution 19 in the processing bath 12 is monitored with a liquid level meter 40. Further, water 42 is automatically supplied appropriately through a water supply tube 44. Liquid overflowing from the processing bath 12 is collected by a collection tank 46.

Further, the etching solution 19 in the processing bath 12 is sucked up with a circulation pump 50 through a suction port 48 with a filter and fed again to the etching solution supply tube 18.

### EXAMPLES

The present invention is described in more detail below by way of examples, but it is understood that the examples are merely illustrative and not intended to be interpreted in a limited way.

A gravure cylinder (plate-making roll) was manufactured through use of NewFX (fully-automatic laser plate making system manufactured by Think Laboratory Co., Ltd.), in which an apparatus having the same configuration as that of the cylinder etching apparatus 10 described above was incorporated as the etching apparatus. As the etching solution, a copper chloride etching solution containing 160 g/L of cupric chloride concentration and 35 g/L of hydrochloric acid concentration was used.

### Example 1

As a cylinder to be processed, a tubular base material of an aluminum core having a circumference of 600 mm and a total length of 1,100 mm was used. Both ends of the cylinder to be processed were chucked, and the cylinder to be processed was loaded into an etching tank. An etching pipe was brought closer to a side surface of the cylinder to be processed up to 100 mm from the cylinder to be processed with a rotation mechanism controlled by a computer, and an etching solution was sprayed onto the cylinder to be processed. The rotation speed of the cylinder to be processed was set to 60 rpm, and the liquid temperature was set to 35° C. Under this condition, the cylinder to be processed was etched to a depth of 20 μm. The time required for etching treatment was 120 seconds. The depth of the cylinder subjected to the etching treatment was measured with a laser microscope. The cylinder to be processed was able to be etched with a uniform depth over the total length thereof. After that, the cylinder to be processed was subjected to plate making through chromium plating, to thereby manufacture a gravure cylinder.

In the above-mentioned embodiment of the present invention, an example in which a gravure cylinder is etched described. However, the present invention is not limited to this example. The present invention may also be similarly applied to a case where other cylinder-like objects to be etched are etched.

### Reference Signs List

10: cylinder etching apparatus of present invention, 12: processing bath, 14: cylinder to be processed, 16: chuck means, 18: etching solution supply tube, 19: etching solution, 20: ejection nozzle, 21: frame, 22: fulcrum, 23: connecting rod, 24: tip end portion, 26: discharge port, 28: washing water, 30: washing water supply tube, 32: water-washing spray nozzle, 34: hydrochloric acid sub-tank, 36: hydrochloric acid supply tube, 38: hydrochloric acid spray nozzle, 40: liquid level meter, 42: water, 44: water supply tube, 46: collection tank, 48: suction port with filter, 50: circulation pump, O: line connecting rotation center of cylinder to be processed and ejection direction of ejection nozzle to each other, P: vertical line from rotation center of cylinder to be processed

1. A cylinder etching apparatus, comprising:
a processing bath;
a chuck means for rotatably holding both ends of a cylinder to be processed in a longitudinal direction of the cylinder to be processed and for accommodating the cylinder to be processed in the processing bath;
at least one etching solution supply tube arranged at a predetermined distance from an outer peripheral surface of the cylinder to be processed along the longitudinal direction in parallel to the outer peripheral surface of the cylinder to be processed along the longitudinal direction; and
a plurality of ejection nozzles juxtaposed in the at least one etching solution supply tube and said plurality of ejection nozzles being configured to eject an etching solution from the at least one etching solution supply tube, wherein the etching solution ejected from the plurality of ejection nozzles through the at least one etching solution supply tube is caused to impinge against a surface of the cylinder to be processed, to thereby etch the surface of the cylinder to be processed, wherein the plurality of ejection nozzles are oriented obliquely upward with respect to a horizontal direction of the cylinder to be processed, wherein an ejection direction of each of the plurality of ejection nozzles is oriented toward a rotation center of the cylinder to be processed from a position that is obliquely downward of the cylinder to be processed, wherein the plurality of ejection nozzles are arranged so as to be brought closer to and away from the outer peripheral surface of the cylinder to be processed.

2. A cylinder etching apparatus according to claim 1, wherein a line connecting the rotation center of the cylinder to be processed and the ejection direction of each of the plurality of ejection nozzles to each other forms an angle of 45°±15° with respect to a vertical line from the rotation center of the cylinder to be processed.

3. A cylinder etching apparatus according to claim 1, wherein the at least one etching solution supply tube comprises a plurality of etching solution supply tubes in which the plurality of ejection nozzles are juxtaposed, wherein the plurality of etching solution supply tubes are arranged in a circumferential direction of the cylinder to be processed, [[and]] wherein the etching solution is ejected so as to be directed toward the rotation center of the cylinder to be processed from a plurality of directions.

4. A cylinder etching apparatus according to claim 1, wherein a total length of each of a plurality of etching solution supply tubes is set to be larger than a total length of the cylinder to be processed, wherein a tip end portion of each of the plurality of etching solution supply tubes forms a discharge port, wherein, in the etching solution passing through each of the plurality of etching solution supply tubes, the etching solution remaining without being ejected from the plurality of ejection nozzles is discharged from the discharge port, to thereby regulate a flow rate of the etching solution passing through each of the plurality of etching solution supply tubes.

5. A cylinder etching method, comprising:
providing a cylinder etching apparatus comprising a processing bath, a chuck means for rotatably holding both ends of a cylinder to be processed in a longitudinal direction of the cylinder to be processed and for accommodating the cylinder to be processed in the processing bath, at least one etching solution supply tube arranged at a predetermined distance from an outer peripheral surface of the cylinder to be processed along the longitudinal direction in parallel to the outer peripheral surface of the cylinder to be processed along the longitudinal direction and a plurality of ejection nozzles juxtaposed in the at least one etching solution supply tube, said plurality of ejection nozzles being configured to eject an etching solution from the at least one etching solution supply tube, wherein the etching solution ejected from the plurality of ejection nozzles through the at least one etching solution supply tube is caused to impinge against a surface of the cylinder to be processed, wherein the plurality of ejection nozzles are oriented obliquely upward with respect to a horizontal direction of the cylinder to be processed, wherein an ejection direction of each of the plurality of ejection nozzles is oriented toward a rotation center of the cylinder to be processed from a position that is obliquely downward of the cylinder to be processed, wherein the plurality of ejection nozzles are arranged so as to be brought closer to and away from the outer peripheral surface of the cylinder to be processed;
etching the outer peripheral surface of the cylinder to be processed through use of the cylinder etching apparatus.

6. A cylinder etching method, comprising:
providing a cylinder etching apparatus comprising a processing bath, a chuck means for rotatably holding both ends of a cylinder to be processed in a longitudinal direction of the cylinder to be processed and for accommodating the cylinder to be processed in the processing bath, at least one etching solution supply tube arranged at a predetermined distance from an outer peripheral surface of the cylinder to be processed along the longitudinal direction in parallel to the outer peripheral surface of the cylinder to be processed along the longitudinal direction and a plurality of ejection nozzles juxtaposed in the at least one etching solution supply tube, said plurality of ejection nozzles being configured to eject an etching solution from the at least one etching solution supply tube, wherein the etching solution ejected from the plurality of ejection nozzles through the at least one etching solution supply tube is caused to impinge against a surface of the cylinder to be processed, wherein the plurality of ejection nozzles are oriented obliquely upward with respect to a horizontal direction of the cylinder to be processed, wherein an ejection direction of each of the plurality of ejection nozzles is oriented toward a rotation center of the cylinder to be processed from a position that is obliquely downward of the cylinder to be processed, wherein the plurality of ejection nozzles are arranged so as to be brought closer to and away from the outer peripheral surface of the cylinder to be processed;
using the cylinder etching apparatus to etch the cylinder.

7. A cylinder etching apparatus according to claim 2, wherein the at least one etching solution supply tube comprises a plurality of etching solution supply tubes in which the plurality of ejection nozzles are juxtaposed, wherein the plurality of etching solution supply tubes are arranged in a circumferential direction of the cylinder to be processed, wherein the etching solution is ejected so as to be directed toward the rotation center of the cylinder to be processed from a plurality of directions.

8. A cylinder etching apparatus according to claim 2, wherein a total length of each of a plurality of etching solution supply tubes is set to be larger than a total length of the cylinder to be processed, wherein a tip end portion of each of the plurality of etching solution supply tubes forms a discharge port, wherein, in the etching solution passing through each of the plurality of etching solution supply tubes, the etching solution remaining without being ejected from the plurality of ejection nozzles is discharged from the discharge port, to thereby regulate a flow rate of the etching solution passing through each of the plurality of etching solution supply tubes.

9. A cylinder etching apparatus according to claim 3, wherein a total length of each of the plurality of etching solution supply tubes is set to be larger than a total length of the cylinder to be processed, wherein a tip end portion of each of the plurality of etching solution supply tubes forms a discharge port, wherein, in the etching solution passing through each of the plurality of etching solution supply tubes, the etching solution remaining without being ejected from the plurality of ejection nozzles is discharged from the discharge port, to thereby regulate a flow rate of the etching solution passing through each of the plurality of etching solution supply tubes.
